(19) United States
(12) Patent Application Publication
(10) Pub. No.: US 2020/0097004 A1
(43) Pub. Date: Mar. 26, 2020

(54) EVOLUTIONARY ALGORITHMIC STATE MACHINE FOR AUTONOMOUS VEHICLE PLANNING

(71) Applicant: CYNGN, INC., Menlo Park, CA (US)

(72) Inventors: Thomas WHITTAKER, Redwood City, CA (US); Jared JENSEN, Mountain View, CA (US)

(73) Assignee: CYNGN, INC., Menlo Park, CA (US)

(21) Appl. No.: 16/577,735

(22) Filed: Sep. 20, 2019

Related U.S. Application Data
(60) Provisional application No. 62/736,362, filed on Sep. 25, 2018.

(51) Int. Cl. G05D 1/00; G06N 3/08; B60W 40/04

(52) U.S. Cl. CPC G05D 1/0088; G06N 3/086; B60W 2050/0062; B60W 2550/22; B60W 40/04

(57) ABSTRACT

Artificial intelligence vehicle systems include vehicle guidance systems and adaptive, evolutionary driving training protocols for state machines. A state machine makes decisions based on information supplied by the sensors attached to the vehicle, the current state of the vehicle, the capabilities of the vehicle, and optionally the applicable traffic laws (e.g., if a roadway vehicle) or facility rules (e.g., if a facility vehicle, such as warehouse, construction site, campus, or the like). An autonomous driver of a state machine decides between possible actions given the current environment where those possible actions to existing conditions are represented by action rules, which may be referred to as “genes.” The adaptive systems enable improved vehicle guidance and can improve over time as new circumstances are encountered and processed.

### THE FIELD OF THE DISCLOSURE

The present disclosure relates to artificial intelligence vehicle systems.

### THE RELEVANT TECHNOLOGY

The present disclosure relates to autonomous vehicle systems. More specifically, for example, the present disclosure includes embodiments related to artificial intelligence vehicle systems including vehicle guidance systems and adaptive, evolutionary driving protocols.

The subject matter claimed herein is not limited to embodiments that solve any disadvantages or that operate only in environments such as those described above. Rather, this section is only provided to illustrate one exemplary technology area where some embodiments described herein may be practiced.

### BRIEF DESCRIPTION OF THE DRAWINGS

FIG. 1 illustrates a flowchart of an example method for training autonomous drivers using evolutionary algorithms.

FIG. 2 is a block diagram of an example artificial intelligence vehicle guidance system.

FIG. 3 illustrates a system for obtaining a suitable autonomous driver.

FIG. 4 shows an example computing device that may be arranged in some embodiments to perform the methods described herein.

### DETAILED DESCRIPTION

The present disclosure includes embodiments that relate to artificial intelligence vehicle systems including vehicle guidance systems and adaptive, evolutionary driving training protocols for state machines. A state machine makes decisions based on information supplied by the sensors attached to the vehicle, the current state of the vehicle, the capabilities of the vehicle, and optionally the applicable traffic laws (e.g., if a roadway vehicle) or facility rules (e.g., if a facility vehicle, such as warehouse, construction site, campus, or the like). An autonomous driver of a state machine decides between possible actions given the current environment where those possible actions to existing conditions are represented by action rules, which may be referred to as “genes.”

Each autonomous driver comprises a list of action rules or “genes” and a logic structure for choosing the gene appropriate for the current scenario. Each action rule describes how the autonomous driver responds to certain conditions which may include both interior vehicle conditions and conditions tied to the external environment, which may change and which may be consistent, and consider both changing conditions and constant conditions. These conditions are called indicators and may include, for example, the position of another vehicle relative to the autonomous vehicle, the position of an environmental object, or the autonomous vehicle's speed and heading as well as the physical environment, road, path, trees, animals, or other. These indicators are gathered by a variety of sensors which may include, for example, cameras, lidar, radar, GSP, IMU, and ultrasonics. These sensors send the indicators to the autonomous driver which then chooses the appropriate action rule to trigger a response as an action outcome.

In some embodiments, if more than one action rule matches one or more given inputs (e.g., indicators), the system makes a determination for selecting an action rule of the matching action rules to use for a given input. In training, some randomness is applied to the matching of action rules to inputs for learning. In execution in a driving scenario, whether virtual or in the real world, the action rule that is selected can have the highest fitness; however, any high value action rule may be selected as appropriate given the driving scenario.

According to various embodiments, a system for training autonomous drivers of state machines may include a training module and a testing module. A training module may include a training cycle wherein vehicle guidance systems undergo a repetitive evolving process of evaluation, ranking, selection, and reproduction in a virtual environment. This process varies autonomous drivers' action rules to select for the action rules, which give the best solution or action output. Solutions as action outputs are ranked according to pre-determined criteria to give a “fitness level” to each set of action rules for correlated indicators. The training environment can provide a large set of randomly generated driving scenarios (e.g., indicators).

In some instances, the fitness level may also be applied to the action rules (e.g., genes). This may include the fitness level being applied to one or more action rules for one or more given inputs (e.g., indicators). The protocol can include evolving one or more action rules that can handle a generalized driving environment, which may include one or more diving conditions (e.g., indicators). For example, an list of action rules (e.g., gene) may be determined to include a plurality of bad action rules that are unfavorable (E.g., a set of bad action rules) and include a small number (e.g., one) of good action rules will result in a lower fitness level compared to a list of action rules with a high number of average rules. The protocol can be configured to select the list of action rules that result in the higher fitness level, which in the example includes more average action rules than when there is a high number of bad action rules with one good action rule. Accordingly, the protocol is configured to select the list of action rules that result in the comparatively higher fitness level than other lists of action rules.

In some embodiments, a testing module may include functions of harvesting autonomous drivers that pass a minimum requirement, testing autonomous drivers in a virtual environment to evaluate generalized fitness parameters, and testing autonomous drivers in physical vehicles.

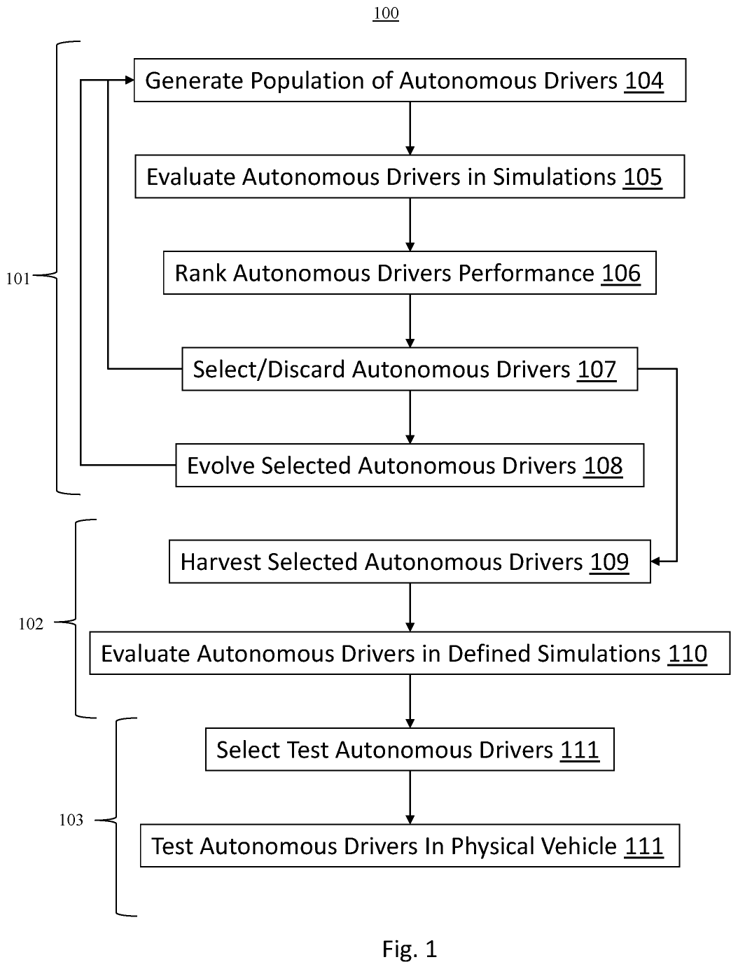

FIG. 1 illustrates a flowchart of an example method for training autonomous drivers using evolutionary algorithms. The method 100 may be implemented partly in a virtual environment and partly at a physical location. The training segment 101 and the testing segment 102 may take place in a virtual environment while the evaluation segment 103 may take place at a physical location.

The process whereby autonomous drivers are trained or evolved to drive is described in training, 101. At block 104, a population of N autonomous drivers is generated. This first generation of N drivers may have randomly generated action rules or hand-written action rules (e.g., coded). For example, an action rule may be randomly generated which tells the autonomous driver the distance at which to stop in front of a stop sign or an action rule may be manually programmed which gives the distance to stop in front of a stop sign.

At block 105, the population of N autonomous drivers is evaluated in simulated driving scenarios in a virtual environment. The autonomous drivers may be evaluated alone or in groups where each autonomous driver controls a virtual vehicle. The simulated driving scenario may be randomly generated and/or may include hand-written (coded) elements. Each autonomous driver may be evaluated in the same driving scenario or one or more autonomous drivers may be evaluated in different driving scenarios.

At block 106, the autonomous drivers are ranked based on fitness of an action outcome in response to an indication. The autonomous drivers are ranked according to certain criteria and assigned a relative fitness level. The criteria for evaluation may be fixed for all generations of autonomous drivers or may be adapted to the fitness of the autonomous drivers. The criteria may be equally weighted or some criteria may have greater weight than others. For example, a crash may have more weight in evaluation than speed of travel. The weight of various criteria may be fixed for all generations of autonomous drivers or may be adapted to the fitness of the autonomous drivers.

At block 107, autonomous drivers having a higher ranking of fitness are selected/preserved and autonomous drivers having a lower ranking of fitness are discarded. A fitness threshold is determined above which autonomous drivers are selected/preserved and below which autonomous drivers are discarded. The fitness threshold may be fixed for all generations of autonomous drivers or it may be adapted to the fitness of the autonomous drivers. The percent of autonomous drivers preserved may be 10% or it may be another value. The autonomous drivers who are selected/preserved may become a part of the next generation of drivers, and thereby the selected/preserved autonomous drivers may be included in the next cycle of the generation of a population of autonomous drivers at block 104.

The population of drivers may be replenished to bring the number of drivers back up to N autonomous drivers (or any number) by copying action rules from the selected/preserved, more fit autonomous drivers and recombining them to create more autonomous drivers, the subsequent generation of autonomous based on the previous generation of autonomous drivers.

At block 108, the selected/preserved autonomous drivers are evolved by evolving the action rules thereof into new evolved autonomous drivers, which are then provided into the generated population of autonomous drivers at block 104. The copied action rules may be recombined randomly or according to an algorithm. Also, some action rules are changed or “mutated.” The selected/preserved autonomous drivers may have their genes mutated and/or the subsequent autonomous drivers may have their genes mutated. The mutation may be random or according to an algorithm.

In training 101, the cycle of evaluation in simulated environments, ranking, and elimination repeats itself for each generation of autonomous drivers. Several generations of autonomous drivers may undergo this process until a certain minimum requirement is met. This minimum requirement may be based off of the evaluation criteria or the completion of a goal. Once a specified number of autonomous drivers of a generation have met the minimum requirement, the autonomous drivers are ranked at block 106 according to fitness. Then, a certain number of the fittest autonomous drivers will be harvested, or pulled into testing, 102. The autonomous drivers may also be copied to continue the training cycle 101. As the training cycle progresses, the highest ranking autonomous drivers are periodically harvested.

At block 109, a certain number of the highest ranking autonomous drivers are harvested, or pulled into testing. In testing, 102, the harvested autonomous drivers are evaluated in a suite of known simulated driving scenarios. In these known simulated driving scenarios, the autonomous drivers may be confronted with elements that they have not seen before. This is done to evaluate whether the evolution of the autonomous drivers has allowed them to handle only those specific elements encountered in training or if their action rules are robust enough to allow them to handle unfamiliar situations. If an autonomous driver performs significantly worse in the testing set 102 than the training set 101, the autonomous driver is discarded. If an autonomous driver's performance is not significantly worse in the testing set 102 than in the training set 101, the autonomous driver is placed in a candidate pool.

Observations from testing 102 can be used to make better fitness functions, add or improve indicators, and add action rules as well as action output in response to indicators. Observations may include observations of how different mutations affected fitness and observations of how autonomous drivers failed to generalize training. To generalize training means to develop a set of action rules that act as general behavioral principles, which allow the autonomous driver to react to elements it has not seen before. If an autonomous driver can successfully react to elements it has not seen before, that autonomous driver has generalized. If an autonomous driver fails to successfully react to elements it has not seen before, that driver has failed to generalize. Failure to generalize may serve as one of the criteria for discarding an autonomous driver in testing 102.

At block 111, autonomous drivers from the candidate pool are transferred into evaluation, 103. The autonomous drivers may be checked against a list of critical factors to ensure they are ready to be tested at a physical location. At block 112, viable candidates are evaluated in a physical vehicle. The autonomous driver acts as the state machine, which controls the vehicle's decision process. The autonomous driver is evaluated according to certain criteria. The criteria for evaluation may be the same criteria used in evaluating the autonomous driver in the virtual environment, or the criteria may be different.

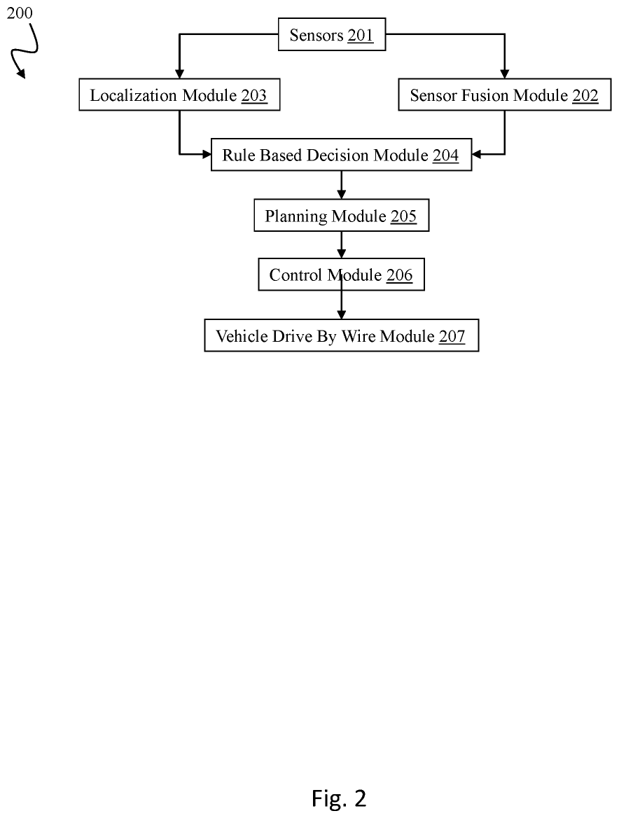

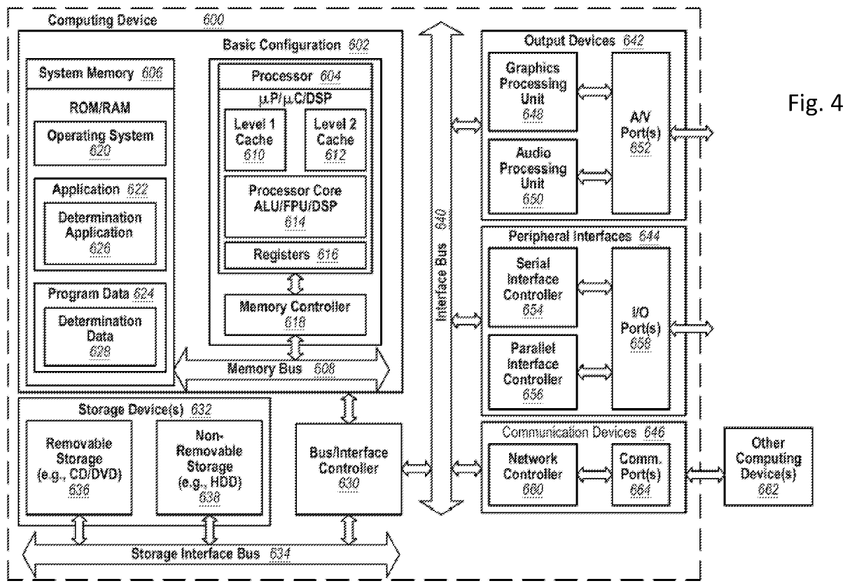

FIG. 2 is a block diagram of an example artificial intelligence vehicle guidance system 200. The artificial intelligence vehicle guidance system 200 may include sensors 201, a sensor fusion module 202, a localization module 203, a rule based decision module 204, a planning module 205, a control module 206, and a vehicle drive-by-wire module 207. One or more example implementations of the artificial intelligence vehicle guidance system 200 are described below. The autonomous driver may include one or more of the rule based decision module 204, planning module 205, control module 206, and vehicle drive-by-wire module 207. These modules may be computer-executable instructions stored on a tangible non-transitory computer memory device, and may be performed with a computer, such as computer 600 of FIG. 4.

The sensors 201 may include, for example, cameras, lidar, radar, GSP, IMU, and ultrasonics. These sensors gather information from the vehicle and the environment. That information is then processed in the sensor fusion module 202 and the localization module 203. The sensor fusion module 202 combines information from all the sensors to form a cohesive dataset of the surrounding environment and the state of the vehicle. The localization module 203 takes information from the sensors and determines the location and velocity of the vehicle relative to environmental elements. The sensor fusion module 202 and the localization module 203 then send processed information to the rule-based decision module 204, the planning module 205, the control module 206, and the vehicle drive-by-wire module 207.

The state machine or autonomous driver of a vehicle may comprise a rule-based decision module 204 and a planning module 205.

The autonomous driver plays a critical role in the rule-based decision module 204 and provides the logic structure for making rule-based decisions based on information from the sensors 201. The rule-based decision module 204 works in tandem with the planning module 205 to determine the actions the vehicle will take. In one embodiment, the rule-based decision module 204 analyzes information from the sensors 201 (e.g., processed date from the localization module 203 and/or sensor fusion module 202) and feeds a decision to the planning module 205. The planning module 205 then extrapolates the consequences of that action and either approves or denies the decision. If the decision is denied, the rules-based decision module 204 may send the next-best decision to the planning module 205. This process may be repeated until the planning module 205 approves a decision from the rules-based decision module 204. The planning module 205 may also extrapolate the trajectory of the vehicle based on the current location, speed, and capabilities of the vehicle and use that information in conjunction with the location of the vehicle to surrounding objects and vehicles to inform the rule-based decision module 204 of future issues. This allows the rule-based decision module 204 to make a better-informed decision on what action to take.

The rule-based decision module 204 sends actions to the control module 206. The control module 206 parses the actions and converts them into a form suitable for the vehicle drive-by-wire module 207. The control module 206 then sends commands (e.g. turn, accelerate, brake) to the vehicle drive-by-wire module 207 to perform the commands.

In some embodiments, a method is provided to train autonomous drivers using evolutionary algorithms. The method can include generating an initial population of autonomous drivers. Each autonomous driver includes an action rule and a logic structure for choosing action outcomes that are appropriate for a given scenario. The method can include evaluating the autonomous drivers in simulated driving scenarios, wherein evaluation includes various measures of fitness where those measures of fitness are optionally associated with certain weights. The autonomous drivers are then ranked based on the measures of fitness. The method can include discarding a portion of the autonomous driver population and preserving a portion of the autonomous driver population. The preserved portion of autonomous driver population is analyzed for the action rule that causes an outcome action for a scenario input, and these action rules are then used to create a second generation of autonomous drivers for a second population thereof. The second generation of autonomous drivers can have action rules that are created from the action rules with preserved measures of fitness. The second generation of autonomous drivers can then undergo a second iteration of the method. This cycle can be performed for N iterations. In one aspect, the preserved action rules can be recombined with original action rules to replenish the 2-N generation autonomous driver population. In some aspects, the method can include repeating the training cycle of evaluating, ranking, discarding, preserving, and creating next generation autonomous drivers for one or for multiple generations. The method can include harvesting the highest ranking autonomous drivers once a certain number of autonomous drivers meet a minimum threshold requirement under the measures of fitness. That is, those autonomous drivers that meet the minimum threshold requirement can be selected as candidate drivers. The method can include testing one or more of the candidate drivers in a simulated environment against a one or more known simulated driving scenarios. The method can then include discarding unsuccessful candidate drivers and putting successful candidate drivers into a candidate driver pool.

After training, the candidate autonomous drivers can then be tested in the real world with physical vehicles in a physical environment. This can include evaluating the candidate drivers from the candidate pool in a physical vehicle in a physical location (e.g., environment).

The training method can include the action rules of the initial population of drivers being randomly generated, handwritten (e.g., coded), or learned from a prior training method as an evolution. The training method can include the driving scenarios used to train the initial population of drivers being randomly generated, handwritten (e.g., coded), or learned from a prior training method as an evolution. In some instances, all autonomous drivers are trained with the same driving scenarios. In other instances, all autonomous drivers are not trained with the same driving scenarios. In some other instances, some autonomous drivers are trained with different driving scenarios. In another instance, at least one autonomous drivers are trained with randomly generated driving scenarios. In some training methods, the various measures of fitness and associated weights are adapted according to the ranking of fitness of the generation of drivers.

In some aspects, the training method can include discarding a portion of the driver population, such as discarding the lowest 90% as ranked by the measure of fitness. However, the selecting can include discarding the lowest 10%, 20%, 25%, 30%, 40%, 50%, 60%, 70%, 75%, 80%, 90%, 95%, 98%, 99%, or 99.9%, or any percentage therebetween.

In some aspects, the action rules of the preserved drivers are mutated or modulated in some manner to create a new autonomous driver with the mutated or modulated action rules. These new autonomous drivers can be included with the selected autonomous drivers, candidate autonomous drivers, or de novo autonomous drivers with de novo action rules. A subsequent generation of autonomous drivers can have action rules that are based on: merging two or more action rules; changing an aspect of an action rule (such as magnitude, vector, reaction time, or other); changing an action rule with a threshold of action being greater than a certain value to a lower value that is lower than an original threshold; changing an action rule with a threshold of action being less than a certain value to a higher value that is higher than an original threshold; changing an outcome of an action rule for a specific indication or stimulus input; changing an action rule to be associated with a different indication or stimulus input; changing associated action outputs to be associated with different indications or stimulus inputs; or combinations thereof.

In some aspects, each training cycle can replenish the autonomous driver population to include new or modified autonomous drivers combined with the selected autonomous drivers and/or candidate autonomous drivers.

In some embodiments, the training method can include testing any generation of autonomous drivers in a simulated environment against a suite of known simulated driving scenarios. In some aspects, the training can include testing any generation of autonomous drivers in scenarios containing elements, indications, or stimuli input that the autonomous drivers have not previously encountered and observing (e.g., recording, analyzing, screening) how the autonomous drivers from one or more generations perform output actions in response thereto. The output actions can be categorized and/or ranked, based on positive output actions, neutral output actions, or negative output actions. In some instances, failure to perform an output action may be selected to discard those autonomous drivers.

The testing method, which can be part of the training method, can include evaluating candidate autonomous drivers from the candidate pool in a physical vehicle in a physical location. This can include having the autonomous driver act as the state machine that controls the decision process for driving the vehicle.

In some embodiments, a state machine of an autonomous vehicle is provided that makes decisions based on information supplied by the sensors attached to the vehicle, the current state of the vehicle, the capabilities of the vehicle, and the applicable traffic laws. The state machine can include the autonomous driver, which can be code stored on a tangible, non-transitory computer memory device. That is, the state machine can be a computer that includes the autonomous driver as described herein. The autonomous driver can be programmed with decision-making logic. The autonomous driver can be generated by the training and testing methods described herein. The state machine can include an autonomous driver created by: generating an initial population of autonomous drivers comprising action rules (e.g., genes) and a logic structure for choosing action rules that are appropriate for a given scenario; evaluating the autonomous drivers in simulated driving scenarios, wherein evaluation includes various measures of fitness where those measures of fitness are optionally associated with certain weights; ranking the autonomous drivers based on the measure of fitness; discarding a portion of the autonomous driver population and preserving a portion of the autonomous driver population; creating recombined action rules from the preserved portion of the autonomous driver population to replenish the total number of the driver population to form a subsequent or N population of autonomous drivers; repeating the training cycle of evaluating, ranking, discarding, preserving, and replenishing the autonomous driver population through N cycles; harvesting the highest ranking autonomous drivers once a certain number of autonomous drivers meet a minimum requirement of one or more measures of fitness; and testing harvested autonomous drivers in a simulated environment against a suite of known simulated driving scenarios; discarding unsuccessful harvested autonomous drivers and putting successful harvested autonomous drivers into a candidate pool of candidate autonomous drivers. Optionally, evaluating candidate autonomous drivers from the candidate pool in a physical vehicle in a physical location can be performed. When successful in a physical vehicle in a physical location, an autonomous driver can then be included in a state machine of an autonomous vehicle.

The state machine can include an autonomous driver that has been trained and/or tested in different protocols. In some aspect, the action rules of the initial population of autonomous drivers are randomly generated, handwritten code, or other. In some aspects, the simulated driving scenarios are randomly generated, handwritten code, or other. In some aspects, the autonomous drivers are all trained in the same simulated driving scenario, or different driving scenarios can be used on different autonomous drivers. In some aspects, the various measures of fitness and associated weights are adapted according to the measures of fitness of the generation of autonomous drivers.

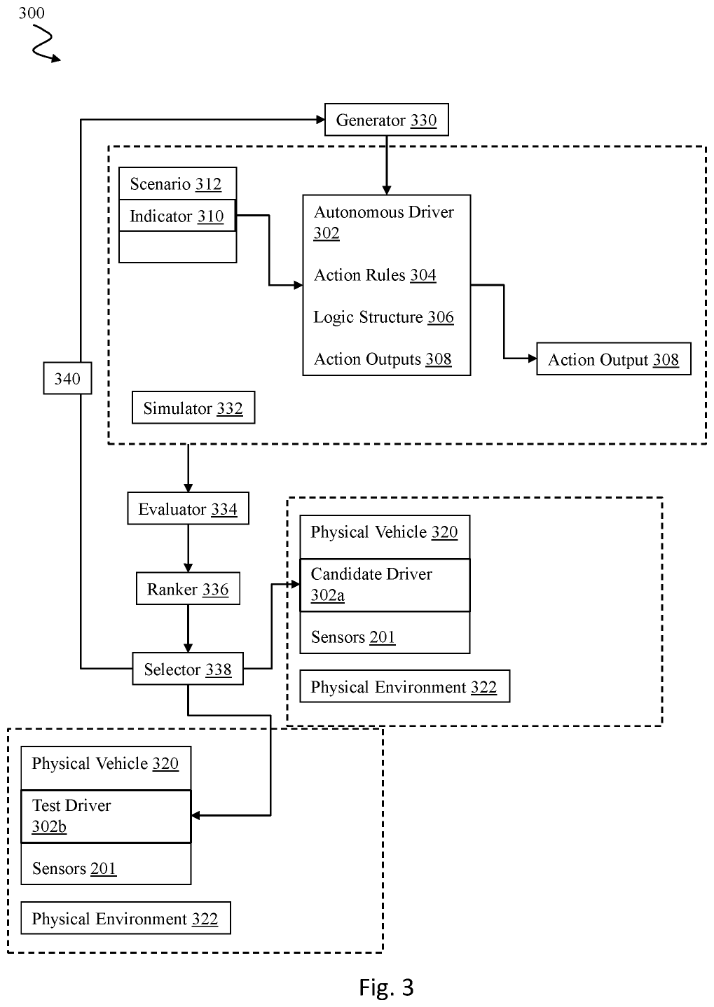

FIG. 3 illustrates a system 300 for obtaining a suitable autonomous driver. The system 300 can be implemented in a method to train autonomous drivers using evolutionary algorithms. The method can include generating an initial population of autonomous drivers 302. Each autonomous driver 302 can include one or more action rules 304 and a logic structure 306 for choosing a first action rule for a first indicator. Each action rule 304 can be correlated with an indicator 310 and have an action output 308 in response to the correlated indicator 310. The method can include simulating N simulated scenarios 312 for each autonomous driver 302, wherein N is an integer. Each simulated scenario 312 can have one or more indicators 310. The method can include evaluating each autonomous driver 302 in the N simulated scenarios 312. Each evaluation can consider an action output 308 for the correlated indicator 310 of an action rule 304. The method can include ranking each autonomous driver 302 based on the evaluation of the autonomous drivers 302. The method can include selecting one or more of the autonomous drivers 302 based on the ranking as one or more candidate drivers 302a. The method may also include performing the generating, simulating, evaluation, ranking and selecting through a plurality of subsequent training cycles 340. Each subsequent training cycle 340 can be evolved from a prior training cycle. In some aspects: the generating is performed with an autonomous driver generator 330; the simulating is performed with a simulator 332; the evaluating is done with an evaluator 334; the ranking is performed with a ranker 336; and/or the selecting is performed with a selector 338. These can be computer programs and can be performed on a computing system.

In some embodiments, the evaluation includes one or more measures of fitness of one or more action rules 304. The evaluation can include one or more measures of fitness of one or more action outputs 308 for the correlated one or more indicators 310. The evaluation can include: one or more measures of fitness that are weighted, the one or more measures of fitness including one or more: action rules 304; one or more action outputs 308 for the correlated one or more indicators 310; or combinations thereof. In some aspects, the evaluating is guided by a measure of fitness associated with a weighting thereof, and the method can further include ranking the autonomous drivers 302 based on the measure of fitness.

In some embodiments, the selecting can include discarding an unselected portion of the population of autonomous drivers 302 and preserving a selected portion of the population of autonomous drivers 302.

In some embodiments, the method can include: identifying one or more of the selected candidate drivers 302a; modulating the action rules 304 of the identified selected candidate drivers 302a; and generating a new population of autonomous drivers 302 having the modulated action rules 304. In some aspects, the modulating includes: merging an action rule 304 from at least two different identified selected candidate drivers 302a; changing an aspect of an action rule 304 (e.g., magnitude, vector, reaction time, or other); changing an action rule 304 with a threshold of action being greater than a certain value to a lower value that is lower than an original threshold; changing an action rule 304 with a threshold of action being less than a certain value to a higher value that is higher than an original threshold; changing an action output 308 of an action rule 304 for a specific indication or stimulus input; changing an action rule 304 to be associated with a different indicator 310 or stimulus input; changing associated action outputs 308 to be associated with different indicators 310 or stimulus inputs; or combinations thereof.

In some embodiments, the method can include generating a subsequent population of autonomous drivers 302 including one or more of the initial autonomous drivers 302 and one or more subsequent autonomous drivers 302 of the subsequent population of autonomous drivers 302.

In some embodiments, the method can include performing the simulating, evaluating, ranking, and selecting with the subsequent population of autonomous drivers 302 through one or more training cycles 340 to obtain an Nth generation candidate drivers 302a. In some aspects, the method can include simulating N different simulated scenarios 312 for each autonomous driver 302 of a subsequent population. Each different simulated scenario 312 can be different from a prior simulated scenario 312.

In some embodiments, the method can include: evaluating each autonomous driver 302 of a subsequent population in the N simulated scenarios 312, each evaluation considers an action output 308 for the indicator 310 of the different simulated scenarios 312; ranking each autonomous driver 302 of the subsequent population based on the evaluation of the autonomous drivers 302 of the subsequent population; and selecting one or more of the autonomous drivers 302 of the subsequent population based on the ranking as one or more candidate drivers 302a as test drivers 302b.

In some embodiments, the training method can include testing the one or more test drivers 302b in a physical vehicle 320 in a physical environment 322. The data from testing can be input into the training method for use in modulating the action rules 304 as well as assigning action outputs 308 for indicators 310. Also, the data from testing can be processed with a pass or fail for the test autonomous driver 302b, where those that pass may be used in the real world. In some aspects, the selected one or more candidate drivers 302a can be provided for testing for autonomous driving of a physical vehicle 320 in a physical environment 322. In some aspects, the selected test drivers 302b can be provided for testing for the autonomous driving of a physical vehicle 320 in a physical environment 322.

In some embodiments, one or more action rules 304 include one or more traffic laws for a defined jurisdiction such that the one or more action outputs 308 comply with the one or more traffic laws. Instead of traffic laws, when the environment where the autonomous driver will operate is not on a road, other rules can be defined and used for consideration. For example, the environment may be a warehouse, construction site, campus (e.g., school or business) or other location, and rules similar to traffic laws can be implemented for consideration and guidance.

In some embodiments, a state machine of an autonomous vehicle is provided that makes decisions based on information supplied by sensors attached to the autonomous vehicle, the current state of the autonomous vehicle, and the capabilities of the autonomous vehicle. The driving decision-making logic can include an autonomous driver evolved by the method of one of the embodiments described herein.

In some embodiments, an autonomous vehicle can have the state machine.

In some embodiments, the system 300 for evolving an autonomous driver can include a computing system (e.g., computer 600 on FIG. 4) having executable code stored on a tangible non-transitory computer memory, that when executed by a processor causes the computing system to perform the method of one of the embodiments.

As used in the present disclosure, the terms “user device” or “computing device” or “non-transitory computer readable medium” may refer to specific hardware implementations configured to perform the actions of the module or component and/or software objects or software routines that may be stored on and/or executed by general purpose hardware (e.g., computer-readable media, processing devices, or some other hardware) of the computing system. In some embodiments, the different components, modules, engines, and services described in the present disclosure may be implemented as objects or processes that execute on the computing system (e.g., as separate threads). While some of the systems and methods described in the present disclosure are generally described as being implemented in software (stored on and/or executed by general purpose hardware), specific hardware implementations or a combination of software and specific hardware implementations are also possible and contemplated. In this description, a “computing device” may be any computing system as previously defined in the present disclosure, or any module or combination of modules running on a computing device.

Evolutionary algorithms (EA) mimic real world evolution in that algorithm configurations that are the “fittest” survive, passing along their algorithm configurations to the next generation of algorithm configurations. There are some basic concepts in EA that can be understood by comparing them to real world examples. Indicators can be data obtained from vehicle and system sensors, which may be raw or processed (distilled) into a form that can be computed. Indicators can be the environment or stimuli that acts on a vehicle. The indicator can be considered the data input into a training system. The action rule can be a rule that defines an action that is based on data and one or more rules, where the action rule determines an action in response to an indicator and a rule. The action rule determines what rules (code) are for an indicator, and determines the action output in response to the indicator. An action rule can be an “if this, then that” logic. For example, if a car is stopped in the road as an “if this”, then the stopping or changing lanes is the “then that.” An autonomous driver can include a list of action rules with the logic to choose an action output in response to an indicator input, or a plurality thereof, to determine which action rule(s) may be appropriate for the current environment, such as indicators. The autonomous driver includes a listing of action rules, along with indicators as input and actions as output in response to indicators, and the autonomous driver (e.g., an algorithm configuration with or without training in an initial or subsequent generation iteration) selects the action rule and action output based on the indicators input. The environment is the “world” the autonomous driver acts in. The environment includes the space where the vehicle (e.g., simulated or physical) of the autonomous driver and the indicators interact. There are differing types of EA systems, some produce a range of values and other produce discrete actions. The actions are the output that is determined by the autonomous driver selecting the rule for an action output in response to one or more indicators input in view of the environment.

Fitness is a method to evaluate a ranking of one autonomous driver against another autonomous driver. The fitness can be a method to evaluate a ranking of an autonomous driver in view of the actions as output that are selected based on the action rules in view of the indicator input with regard to the vehicle, autonomous driver, and environment.

Indicators can be distilled inputs from the sensors of the vehicle. Other systems can determine what is a person or truck, the location of objects and the predicted behavior of an object. Examples of indicators include: Speed, Location, Heading, Objects Type (Person, Vehicle, Tree), Objects Location; or Objects' predicted vector of movement.

Action rules are readable expressions of indicators with operations that result in an action. A simple example might be: <times_fired=N,rule_fitness=M object.predicted_path==intercept && object.intercept_distance <my.stopping_distance && path.left_lane_open==true && path.left_lane_path.intercept.object==false >=>path.left_lane_aggressive. This action rule can be evaluated by the EA code. This example can be performed if a vehicle sensor determined that an object was in its path that was too close for it to stop for, check if changing lanes was an option, and its associated action is to change lanes instead of trying to stop and crashing into the object.

The fitness of such an action output is favorable, and obtains a high rating for avoiding a crash. Each autonomous driver can have hundreds or thousands or more of action rules and each action rule can have a large number of output actions that can be selected based on indicator input. Calculating fitness can be programmed and evolved through one or more evolution iterations. Action outputs can be characterized on safety, accident avoidance, amount of force generated by the action, amount of sway or yaw generated by the action, the acceleration and/or deceleration rate, or other driving actions. The goal of fitness is to provide safe driving that is as close to a human driver or better that follows the laws of the road as well as rules for a pleasant and uneventful ride (e.g., less lane changing, or gradual changes instead of rapid fast jerky changes). For example if the sole metric for calculating fitness was collision avoidance, the system might learn only to stop at stop signs when there were no other vehicles around. A programmer can hand code a rule to always stop at stop signs, but the preferred way in EA is for the system to learn through iterations and cycles so the training can penalize the fitness for breaking traffic laws or other rules, whether learned or coded. The advantage of the EA system of training is when a situation where breaking a traffic law prevents a collision, the system would be free to learn that action rule and action output for the indicators of the situation, where with hard coded rules the system cannot learn from positive actions and/or negative actions that are assigned a fitness evaluation. Similar erratic output actions such as unsafe or reckless driving can be penalized with low fitness scores, where safe smooth driving actions can be favored with high fitness scores. The autonomous driver can be programmed to maximize fitness scores when choosing an action output in response to an indicator input.

In an example, the EU recently mandated that if an autonomous vehicle can only hit a person or another vehicle, the autonomous vehicle should hit the vehicle (e.g., under the assumption a person in a vehicle has airbags, seatbelts and a better chance of surviving than a vehicle-person collision). Such a specific situation can be hard coded or evolved using the methods described herein. For example, the testing system (or autonomous driver) can be configured such that there is a significantly higher fitness penalty for hitting a person compared to the much lower fitness penalty for hitting a vehicle. This allows any set of circumstances to evolve the correct choice over iterations of the training.

In the autonomous driving scenario, the autonomous driver has a set of driving rules (e.g., algorithm configuration) along with the parameters of a vehicle (e.g., kinematics, size, weight, current speed, location, etc.). For every discrete unit of time (e.g., nanosecond, millisecond, etc.), the autonomous driver obtains indicator input for the current information regarding the environment and objects therein. The autonomous driver can then apply its intrinsic values and the values from the environment and indicators to its action rule set and then execute the action output defined by the action rule that meet the current criteria (e.g., one or more indicators). If more than one action rule is activated, then the action rule with the highest fitness is chosen during training, testing and driving. In training, randomness is induced to allow younger rules, such as those generated and evolved through the training cycles, a chance to be evaluated.

An autonomous vehicle receives data regarding the world through its sensors. In the EA training system, the environment is defined by the output of the sensors in the system. Other machine learning techniques can be used to interpret the input of the sensor. For example, a deep neural network (DNN) can be used to identify an object as a car or truck based on the data from the camera pipeline, which can be the sensor fusion module. The sensor fusion module can merge camera data and LIDAR data to produce a list of objects and their positions relative to the autonomous vehicle and map. The sensors can provide the data to the localization module in order to establish where the vehicle is, such as on a map, as well as a vector of the vehicle on the map and possibly relative to objects in the environment. The EA system can be used to train the autonomous driver to predict the future positions of the objects in the vehicle's environment and/or relative to a map. The system can train the autonomous driver to determine the state of the vehicle and the surrounding environment, and decide action outputs the vehicle should take.

The following provides an example training protocol in the EA environment. A population of autonomous drivers can be created with a random set of manually crafted (e.g., programmed) action rules. The autonomous drivers of the population are run through a set of N random simulated scenarios that include indicators. The fitness of action output for the indicators for each autonomous driver is evaluated. A ranking based on the fitness is performed to stratify the worse performing autonomous drivers and the best performing autonomous drivers. A threshold cutoff is defined or a certain number of selectable autonomous drivers is selected and the rest are discarded. For example, only the top N (usually 20%) are selected and preserved. In the next training cycle, the population of autonomous drivers is then filled out or repopulated by creating new autonomous drivers with new action rules that have not yet been evaluated and/or with action rules created by modifying the action rules of selected and preserved autonomous drivers. The modified action rules can be: by merging the action rules of two or more autonomous drivers; deleting one or more action rules; mutation of the action rules; changing a greater than action rule to a less than action rule or vice versa; changing the action output of an action rule; changing indicators associated with an action rule and/or action output; as well as other modifications. The new and modified autonomous drivers are combined with the selected and preserved autonomous driver, and the next training cycle is performed. This allows for evolution of the autonomous driver over training iterations. For example, this process can be repeated millions of times or more. Candidate autonomous drivers that meet the fitness threshold can be pulled out of the pool of autonomous drivers and tested against a large number of driving scenarios, which can include previously navigated scenarios as well as new scenarios that were previously not encountered by the autonomous driver.

In some embodiments, the EA training system keeps track of the number of times an action rule has been used. Typically, if an action rule in an autonomous driver falls below a certain threshold it can be removed. However, if the action rule is needed for uncommon safety parameters, the action rule can be marked for permanent storage and consideration. Individual action rules can be tested and unsafe action rules can be removed. Output actions in response to certain indicators that are mandated, such as by law or rule, can be added into the system manually.

The following can provide an outline for the EA training system for autonomous drivers. Training: Random population of autonomous drivers have randomly generated rules and written rules; Evaluate each autonomous driver in an emulated driving environment, random driving scenarios, and handwritten driving scenarios; Rank autonomous drivers in various measures of fitness, various weights of different measures of fitness, adaptive weights (e.g., speed gets more important as crashes disappear), adaptive critical fitness parameters (crashes) handwritten or planned, relative ranking system, same driving scenarios for all automated drivers, different driving scenarios for different autonomous drivers; Discard bad autonomous drivers such as discarding drivers with lowest fitness ranking; Reproduce autonomous drivers to refill pool in subsequent generation, such as by recombining action rules from good drivers, keeping or modulating surviving drivers, and mutate action rules of surviving drivers; and Repeat.

Testing: Harvest good autonomous drivers by establishing minimum requirement, and when best drivers meet requirement, put them in testing; Test good autonomous drivers by standardized driving course with elements autonomous drivers have not seen before, randomized course consisting of elements drivers have not seen before, test for generalized fitness, discard autonomous drivers whose performance suffers in testing, mark good autonomous drivers for road evaluation; evaluate best autonomous drivers in physical vehicle on physical road, where best autonomous drivers from testing operate in actual vehicles, set criteria for fitness on road, discard autonomous drivers who fail in physical vehicle on physical road.

In some instances, data is collected in the road test and implemented in the training. In other instances, data collected in the road test is not used in training to prevent contamination and overfitting during training.

In one embodiment, the present methods can include aspects performed on a computing system. As such, the computing system can include a memory device that has the computer-executable instructions for performing the methods. The computer-executable instructions can be part of a computer program product that includes one or more algorithms for performing any of the methods of any of the claims.

In one embodiment, any of the operations, processes, or methods, described herein can be performed or cause to be performed in response to execution of computer-readable instructions stored on a computer-readable medium and executable by one or more processors. The computer-readable instructions can be executed by a processor of a wide range of computing systems from desktop computing systems, portable computing systems, tablet computing systems, hand-held computing systems, as well as network elements, and/or any other computing device. The computer readable medium is not transitory. The computer readable medium is a physical medium having the computer-readable instructions stored therein so as to be physically readable from the physical medium by the computer/processor.

There are various vehicles by which processes and/or systems and/or other technologies described herein can be effected (e.g., hardware, software, and/or firmware), and that the preferred vehicle may vary with the context in which the processes and/or systems and/or other technologies are deployed. For example, if an implementer determines that speed and accuracy are paramount, the implementer may opt for a mainly hardware and/or firmware vehicle; if flexibility is paramount, the implementer may opt for a mainly software implementation; or, yet again alternatively, the implementer may opt for some combination of hardware, software, and/or firmware.

The various operations described herein can be implemented, individually and/or collectively, by a wide range of hardware, software, firmware, or virtually any combination thereof. In one embodiment, several portions of the subject matter described herein may be implemented via application specific integrated circuits (ASICs), field programmable gate arrays (FPGAs), digital signal processors (DSPs), or other integrated formats. However, some aspects of the embodiments disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and/or firmware are possible in light of this disclosure. In addition, the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a physical signal bearing medium include, but are not limited to, the following: a recordable type medium such as a floppy disk, a hard disk drive (HDD), a compact disc (CD), a digital versatile disc (DVD), a digital tape, a computer memory, or any other physical medium that is not transitory or a transmission. Examples of physical media having computer-readable instructions omit transitory or transmission type media such as a digital and/or an analog communication medium (e.g., a fiber optic cable, a waveguide, a wired communication link, a wireless communication link, etc.).

It is common to describe devices and/or processes in the fashion set forth herein, and thereafter use engineering practices to integrate such described devices and/or processes into data processing systems. That is, at least a portion of the devices and/or processes described herein can be integrated into a data processing system via a reasonable amount of experimentation. A typical data processing system generally includes one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems, including feedback loops and control motors (e.g., feedback for sensing position and/or velocity; control motors for moving and/or adjusting components and/or quantities). A typical data processing system may be implemented utilizing any suitable commercially available components, such as those generally found in data computing/communication and/or network computing/communication systems.

The herein described subject matter sometimes illustrates different components contained within, or connected with, different other components. Such depicted architectures are merely exemplary, and that in fact, many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include, but are not limited to: physically mateable and/or physically interacting components and/or wirelessly interactable and/or wirelessly interacting components and/or logically interacting and/or logically interactable components.

FIG. 4 shows an example computing device 600 (e.g., a computer) that may be arranged in some embodiments to perform the methods (or portions thereof) described herein. In a very basic configuration 602, computing device 600 generally includes one or more processors 604 and a system memory 606. A memory bus 608 may be used for communicating between processor 604 and system memory 606.

Depending on the desired configuration, processor 604 may be of any type including, but not limited to: a microprocessor (μP), a microcontroller (μC), a digital signal processor (DSP), or any combination thereof. Processor 604 may include one or more levels of caching, such as a level one cache 610 and a level two cache 612, a processor core 614, and registers 616. An example processor core 614 may include an arithmetic logic unit (ALU), a floating point unit (FPU), a digital signal processing core (DSP Core), or any combination thereof. An example memory controller 618 may also be used with processor 604, or in some implementations, memory controller 618 may be an internal part of processor 604.

Depending on the desired configuration, system memory 606 may be of any type including, but not limited to: volatile memory (such as RAM), non-volatile memory (such as ROM, flash memory, etc.), or any combination thereof. System memory 606 may include an operating system 620, one or more applications 622, and program data 624. Application 622 may include a determination application 626 that is arranged to perform the operations as described herein, including those described with respect to methods described herein. The determination application 626 can obtain data, such as pressure, flow rate, and/or temperature, and then determine a change to the system to change the pressure, flow rate, and/or temperature.

Computing device 600 may have additional features or functionality, and additional interfaces to facilitate communications between basic configuration 602 and any required devices and interfaces. For example, a bus/interface controller 630 may be used to facilitate communications between basic configuration 602 and one or more data storage devices 632 via a storage interface bus 634. Data storage devices 632 may be removable storage devices 636, non-removable storage devices 638, or a combination thereof. Examples of removable storage and non-removable storage devices include: magnetic disk devices such as flexible disk drives and hard-disk drives (HDD), optical disk drives such as compact disk (CD) drives or digital versatile disk (DVD) drives, solid state drives (SSD), and tape drives to name a few. Example computer storage media may include: volatile and non-volatile, removable and non-removable media implemented in any method or technology for storage of information, such as computer readable instructions, data structures, program modules, or other data.

System memory 606, removable storage devices 636 and non-removable storage devices 638 are examples of computer storage media. Computer storage media includes, but is not limited to: RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which may be used to store the desired information and which may be accessed by computing device 600. Any such computer storage media may be part of computing device 600.

Computing device 600 may also include an interface bus 640 for facilitating communication from various interface devices (e.g., output devices 642, peripheral interfaces 644, and communication devices 646) to basic configuration 602 via bus/interface controller 630. Example output devices 642 include a graphics processing unit 648 and an audio processing unit 650, which may be configured to communicate to various external devices such as a display or speakers via one or more A/V ports 652. Example peripheral interfaces 644 include a serial interface controller 654 or a parallel interface controller 656, which may be configured to communicate with external devices such as input devices (e.g., keyboard, mouse, pen, voice input device, touch input device, etc.) or other peripheral devices (e.g., printer, scanner, etc.) via one or more I/O ports 658. An example communication device 646 includes a network controller 660, which may be arranged to facilitate communications with one or more other computing devices 662 over a network communication link via one or more communication ports 664.

The network communication link may be one example of a communication media. Communication media may generally be embodied by computer readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), microwave, infrared (IR), and other wireless media.

The term computer readable media as used herein may include both storage media and communication media.

Computing device 600 may be implemented as a portion of a small-form factor portable (or mobile) electronic device such as a cell phone, a personal data assistant (PDA), a personal media player device, a wireless web-watch device, a personal headset device, an application specific device, or a hybrid device that includes any of the above functions. Computing device 600 may also be implemented as a personal computer including both laptop computer and non-laptop computer configurations. The computing device 600 can also be any type of network computing device. The computing device 600 can also be an automated system as described herein.

The embodiments described herein may include the use of a special purpose or general-purpose computer including various computer hardware or software modules.

Embodiments within the scope of the present invention also include computer-readable media for carrying or having computer-executable instructions or data structures stored thereon. Such computer-readable media can be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures and which can be accessed by a general purpose or special purpose computer. When information is transferred or provided over a network or another communications connection (either hardwired, wireless, or a combination of hardwired or wireless) to a computer, the computer properly views the connection as a computer-readable medium. Thus, any such connection is properly termed a computer-readable medium. Combinations of the above should also be included within the scope of computer-readable media.

Computer-executable instructions comprise, for example, instructions and data which cause a general purpose computer, special purpose computer, or special purpose processing device to perform a certain function or group of functions. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

In accordance with common practice, the various features illustrated in the drawings may not be drawn to scale. Accordingly, the dimensions of the various features may be arbitrarily expanded or reduced for clarity. In addition, some of the drawings may be simplified for clarity. Thus, the drawings may not depict all of the components of a given apparatus (e.g., device) or all operations of a particular method.

Terms used in the present disclosure and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” among others).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations.

In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

Additionally, the use of the terms “first,” “second,” “third,” etc., are not necessarily used herein to connote a specific order or number of elements. Generally, the terms “first,” “second,” “third,” etc., are used to distinguish between different elements as generic identifiers. Absence a showing that the terms “first,” “second,” “third,” etc., connote a specific order, these terms should not be understood to connote a specific order. Furthermore, absent a showing that the terms “first,” “second,” “third,” etc., connote a specific number of elements, these terms should not be understood to connote a specific number of elements.

All examples and conditional language recited in the present disclosure are intended for pedagogical objects to aid the reader in understanding the invention and the concepts contributed by the inventor to furthering the art, and are to be construed as being without limitation to such specifically recited examples and conditions. Although embodiments of the present disclosure have been described in detail, it should be understood that the various changes, substitutions, and alterations could be made hereto without departing from the spirit and scope of the present disclosure.

As used in the present disclosure, the terms “module” or “component” may refer to specific hardware implementations configured to perform the actions of the module or component and/or software objects or software routines that may be stored on and/or executed by general purpose hardware (e.g., computer-readable media, processing devices, and/or others) of the computing system. In some embodiments, the different components, modules, engines, and services described in the present disclosure may be implemented as objects or processes that execute on the computing system (e.g., as separate threads). While some of the system and methods described in the present disclosure are generally described as being implemented in software (stored on and/or executed by general purpose hardware), specific hardware implementations or a combination of software and specific hardware implementations are also possible and contemplated. In the present disclosure, a “computing entity” may be any computing system as previously defined in the present disclosure, or any module or combination of modulates running on a computing system.

1. A method to train autonomous drivers using evolutionary algorithms, the method comprising:
generating an initial population of autonomous drivers, each autonomous driver including one or more action rules and a logic structure for choosing a first action rule for a first indicator, each action rule being correlated with an indicator and having an action output in response to the correlated indicator;
simulating N simulated scenarios for each autonomous driver, each simulated scenario having one or more indicators, wherein N is an integer;
evaluating each autonomous driver in the N simulated scenarios, each evaluation considers an action output for the correlated indicator of an action rule;
ranking each autonomous driver based on the evaluation of the autonomous drivers;
selecting one or more of the autonomous drivers based on the ranking as one or more candidate drivers; and
performing the generating, simulating, evaluation, ranking and selecting through a plurality of subsequent training cycles, wherein each subsequent training cycle is evolved from a prior training cycle.

2. The method of claim 1, wherein:
the generating is performed with an autonomous driver generator;
the simulating is performed with a simulator;
the evaluating is done with an evaluator;
the ranking is performed with a ranker; and
the selecting is performed with a selector.

3. The method of claim 1, wherein the evaluation includes one or more measures of fitness of one or more action rules.

4. The method of claim 1, wherein the evaluation includes one or more measures of fitness of one or more action outputs for the correlated one or more indicators.

5. The method of claim 1, wherein the evaluation includes one or more measures of fitness that are weighted, the one or more measures of fitness including one or more of:
action rules;
one or more action outputs for the correlated one or more indicators; and
combinations thereof.

6. The method of claim 1, wherein the evaluating is guided by a measure of fitness associated with a weighting thereof, the method further comprising ranking the autonomous drivers based on the measure of fitness.

7. The method of claim 6, wherein the selecting includes discarding an unselected portion of the population of autonomous drivers and preserving a selected portion of the population of autonomous drivers.

8. The method of claim 1, further comprising:
identifying one or more of the selected candidate drivers;
modulating the action rules of the identified selected candidate drivers; and
generating a new population of autonomous drivers having the modulated action rules.

9. The method of claim 8, wherein the modulating includes:
merging an action rule from at least two different identified selected candidate drivers;
changing an aspect of an action rule;
changing an action rule with a threshold of action being greater than a certain value to a lower value that is lower than an original threshold;
changing an action rule with a threshold of action being less than a certain value to a higher value that is higher than an original threshold;
changing an action output of an action rule for a specific indication or stimulus input;
changing an action rule to be associated with a different indicator or stimulus input;
changing associated action outputs to be associated with different indicators or stimulus inputs; or
combinations thereof.

10. The method of claim 8, further comprising generating a subsequent population of autonomous drivers including one or more of the initial autonomous drivers and one or more subsequent autonomous drivers of the subsequent population of autonomous drivers.

11. The method of claim 10, further comprising performing the simulating, evaluating, ranking, and selecting with the subsequent population of autonomous drivers through one or more training cycles to obtain a Nth generation candidate drivers.

12. The method of claim 11, further comprising:
simulating N different simulated scenarios for each autonomous driver of a subsequent population, each different simulated scenario being different from a prior simulated scenario.

13. The method of claim 12, further comprising:
evaluating each autonomous driver of a subsequent population in the N simulated scenarios, each evaluation considers an action output for the indicator of the different simulated scenarios;
ranking each autonomous driver of the subsequent population based on the evaluation of the autonomous drivers of the subsequent population; and
selecting one or more of the autonomous drivers of the subsequent population based on the ranking as one or more candidate drivers as test drivers.

14. The method of claim 13, further comprising testing the one or more test drivers in a physical vehicle in a physical environment.

15. The method of claim 1, further comprising the selected one or more candidate drivers being provided for testing for autonomous driving of a physical vehicle in a physical environment.

16. The method of claim 14, further comprising the selected test drivers being provided for testing for autonomous driving of a physical vehicle in a physical environment.

17. The method of claim 1, wherein one or more action rules include one or more traffic laws for a defined jurisdiction such that the one or more action outputs comply with the one or more traffic laws.

18. A state machine of an autonomous vehicle that makes decisions based on information supplied by sensors attached to the autonomous vehicle, the current state of the autonomous vehicle, and the capabilities of the autonomous vehicle, wherein driving decision-making logic includes an autonomous driver evolved by the method of claim 1.

19. An autonomous vehicle having the state machine of claim 18.

20. A system for evolving an autonomous driver comprising:
a computing system having executable code stored on a tangible non-transitory computer memory, that when executed by a processor causes the computing system to perform the method of claim 1.
